(19) United States
(12) Patent Application Publication
(10) Pub. No.: US 2004/0189804 A1
(43) Pub. Date: Sep. 30, 2004

(54) Method of selecting targets and generating feedback in object tracking systems

(76) Inventors: George R. Borden IV, Vancouver, WA (US); Jeffrey B. Sampsell, Vancouver, WA (US); Richard Qian, Camas, WA (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/821,294

(22) Filed: Apr. 9, 2004

Related U.S. Application Data
(63) Continuation of application No. 09/505,449, filed on Feb. 16, 2000.

(51) Int. Cl. H04N 5/225

(52) U.S. Cl. 348/169

(57) ABSTRACT

A system initiates an object tracking system, magnifies the image, selects an object of interest in an image, and designates the object as the target all while the object tracking system is activated. In this manner it is easier for the user of the object tracking system to select the target, especially if the target tends to be moving fast.

### CROSS-REFERENCE TO RELATED APPLICATIONS

This is a continuation of application Ser. No. 09/505,449, filed Feb. 16, 2000.

### BACKGROUND OF THE INVENTION

The present invention relates to an improved video capture and display system.

Object tracking systems are used for auto focusing, auto zoom, and other functions of video cameras. Likewise, object tracking systems are used for auto zoom, brightness adjustment, contrast adjustment, and highlighting functions of video display systems. Imaging devices in video cameras capture images by converting light into electrical signals through a photoelectric process. On the other hand, video display devices utilize electrical signals to control a light source producing an image. Object tracking systems use a number of known methods to process the electrical signals corresponding to an image and to extract a group of signals representing a designated target of the object tracking system. The group of signals representing the target object is relocated and “followed” in the succession of images or frames making up a video sequence.

To initiate the tracking process, a target must be initially identified for the object tracking system. Object tracking systems may automatically identify a target object based on an assumed usage model for the video capture or display device. For example, the object of interest will most likely to be located near the center of the image and may be the larger object in the vicinity. However, automatic target designation is complex and is problematic if the object of interest is not centrally located in the image, is one of a plurality of similar objects in the vicinity, or if there is little contrast between the object of interest and the surroundings.

User designation of the target object avoids some of the limitations and complexities of automatic target designation. Nishimura et al., U.S. Pat. No. 5,631,697, for VIDEO CAMERA CAPABLE OF AUTOMATIC TARGET TRACKING, describe a system in which the user designates the target by aligning an electronic marker generated in the viewfinder with the image of the intended target object and then depressing a switch to activate the target tracking processor. While less complex and more flexible than fully automatic target designation, the system provides only for user designation of the target object's location.

To separate the group of signals representing the target object from the larger group of signals representing the image, target tracking systems utilize information about the size the target object, as well as its location. Automatic or manual methods may be used to designate the target's size once its location has been manually designated. Automatic determination of the target object's size is complex and often unreliable, especially in crowded or low contrast images. To reduce the complexity of the tracking system and increase the reliability of target identification, the system may permit the user to designate the target's size. For example, the target object's size may be designated by drawing an “electronic” box bounding the target object. However, drawing a box around a moving target while operating a video camera is not easily accomplished and even locating a target in a viewfinder when there is little contrast between the target object and the surroundings or when the target is located at a distance may be difficult for a user.

What is desired, therefore, is a method of designating a target object for an object tracking system that allows the user to easily locate the target object and reliably designate its location and size for the tracking system. Further, a method of notifying the user of the continuing performance of the tracking system is desired.

### SUMMARY OF THE INVENTION

The present invention overcomes the aforementioned drawbacks of the prior art by providing an object tracking system that includes initiating the object tracking system, magnifying the image, selecting an object of interest in an image, and designating the object as the target all while the object tracking system is activated. In this manner it is easier for the user of the object tracking system to select the target, especially if the target tends to be moving fast.

In another aspect of the object tracking system an image is magnified and an object is designated as the target for tracking by the tracking system. In response to designating the object the scale of the image is automatically changed. In one embodiment, this permits the user to zoom in on the image, select the target more easily, and then automatically zoom out, which permits easier selection of the target.

In yet another aspect of the object tracking system monitors a level of confidence that the tracking system is properly tracking the target. In response to a change in the level of confidence the magnification of the image visible to the operator is altered.

The foregoing and other objectives, features and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram of a video camera employing the method of the present invention.

FIG. 2 is a flow chart of object tracking functionality.

FIG. 3 is an exemplary viewfinder image of the video camera of FIG. 1.

FIG. 4 is a magnified view of the exemplary viewfinder image of FIG. 2.

### DETAILED DESCRIPTION OF THE PREFERRED EMBODIMENT

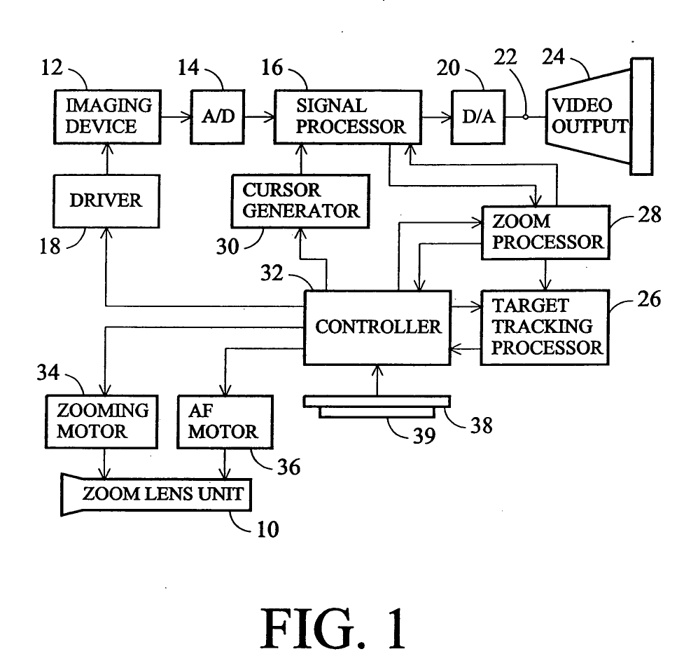

Referring to FIG. 1, a video camera according to the present invention includes video capture and display systems. The video camera includes a lens unit 10, an imaging device 12 which may be a charge coupled device (CCD) or metal oxide semiconductor (MOS) array, an A/D (analog to digital) converter 14, a signal processor 16, a driver 18 to drive the imaging device 12, and a D/A (digital to analog) convertor 20. The imaging device 12 includes a plurality of photoelectric elements arranged in a two-dimensional array on one surface. The light of an optical image is focused on the photoelectric elements of the imaging device 12 by the lens unit 10. Each photoelectric element converts the light from the image that is striking the element into an analog electrical signal. Periodically, the driver 18 connects elements of the imaging device 12 to the A/D converter 14 causing the electrical signals produced by the elements of the imaging device 12 to be converted to digital signals which are read by the signal processor 16. The signal processor 16 converts the digital signals to composite video signals representing the luminance and chrominance of the light striking each element of the imaging device 12. The composite video signals are output to the D/A converter 20 for conversion to the analog signals of the camera's video output 22. The video output 22 may be transmitted or recorded and is displayed on a viewfinder 24 so that the user can visualize the images being transmitted or recorded by the camera.

The video camera also includes a target tracking processor 26 that processes the output of the signal processor 16 to extract signals representing the target object from the signals representing the image in the succession of images or frames making up the video sequence. The video camera includes a zoom processor 28, a cursor generator 30, and a controller 32. The camera may also include a zooming motor 34 and an auto focus motor 36 driving the zooming and focusing mechanisms of the lens unit 10. As the lens 10 zooms in or out, the optical image is magnified on the imaging device 12 producing a magnified image at the video output 22 and in the display of the viewfinder 24. It is to be understood that magnification may include the result of zooming in or zooming out. On the other hand, zooming may be accomplished by processing signals from a region of the imaging device 12. The zoom processor 28 may extract signals from a portion of the imaging device 12 and calculate zoom information from those signals to electronically magnify a portion of the image that is displayed in the viewfinder 24.

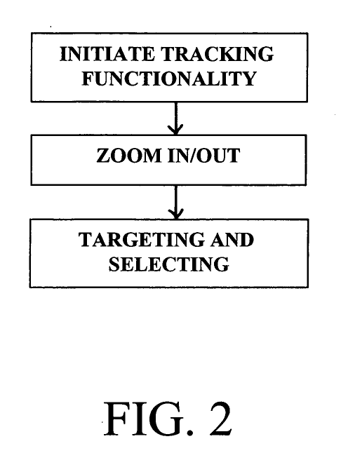

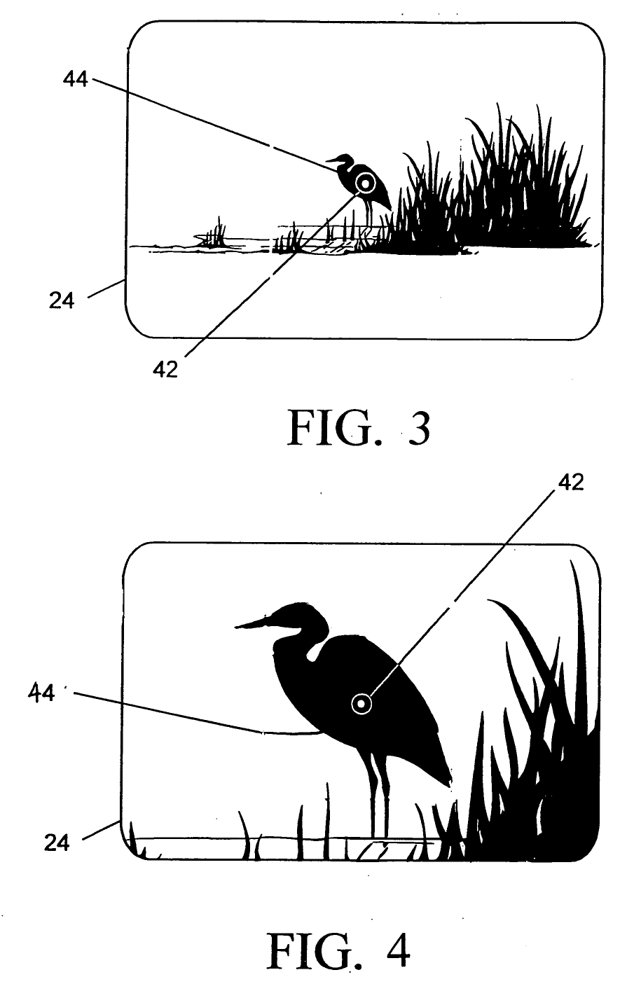

Traditional video tracking systems include the user zooming in or zooming out until the object is clearly visible within the display and then the user initiates the tracking functionality. Thereafter, the user then selects the target to be tracked by the video tracking system. The present inventor came to the realization that while a workable technique for tracking targets, it is clumsy because by the time the user initiates the tracking functionality and then selects the target, the target may have already moved out of the field of view. This is especially true when the object takes up a significant portion of the display, such as when under extreme zoom. To overcome these limitations the present inventors have developed a new interface for a tracking system. Referring to FIGS. 2 and 3, first the tracking functionality is initialized by any appropriate technique. Next, the target is located, sized, and positioned on an electronic viewfinder 24 for accurately selecting and subsequent tracking. A cursor 42 is generated by the cursor generator 30 and is superimposed on the image in the electronic viewfinder 24. The cursor 40 may be in a fixed location in the viewfinder 24 (e.g., centered) and positioned over the image of the target object by movement of the camera which effectively moves the viewfinder image behind the cursor 42. On the other hand, the cursor may be movable and electronically positioned in the viewfinder image by operation of a joystick, touch pad or other pointing device 38 (refer to FIG. 1). A target designator switch 39 facilitates signaling the controller 32 that a target is being designated for tracking. The target designator switch 39 and the pointing device 38 may be combined into a single control element permitting the user to conveniently position a movable cursor 42 and designate the target. A movable cursor 42 permits the user to designate target objects that are not centered in the image. To initiate tracking, the user aligns the cursor 42 to superimpose the cursor 42 on the target object and actuates the target designator switch 39. Preferably, the target designator switch 39 and the pointing device 38 are combined by touch sensitive viewfinder 24. In this manner, the user may simply target and select the target to be tracked by a single action. The physical activity used on the video camera for targeting and selecting (e.g., buttons and controls) are preferably different than that used for zooming, which permits the targeting and selecting functions to be placed into a “ready” state. In the case of the touch screen viewfinder 24, while touching the viewfinder 24 may be used for many different functions, after initialing the tracking functionality the touch screen viewfinder's next function is automatically set to targeting and selecting of the target. Accordingly, after zooming a single action of touching the viewfinder 24 screen will perform targeting and selecting in a fast and efficient manner before the target, especially if moving fast, is no longer displayed on the viewfinder 24.

In one embodiment of the present invention, actuation of the target designator switch 39 causes the controller 36 to signal the zoom processor 28 to begin zooming. The zoom processor 28 performs the zoom calculation or actuates the zoom motor 34 causing the zoom lens unit 34 to zoom in, magnifying the image in the viewfinder 24. Referring to FIG. 4, the image in the viewfinder 24 is magnified until the target object 44 is easy to view and designate. The user then designates the target object by actuating the target designator switch 39 for a second time. This may likewise be performed by a touch sensitive viewfinder 24 where after initiating tracking functionality the user touches the screen to start zooming and touches the screen a second time to designate the target. The first zooming may be automatic, if desired. Designation of the target causes the target tracking processor 26 to extract the signals representing a target designated at the location of the cursor (or touch on the screen) from the signals of the image in a scan of the imaging device 12. A target may be identified in any manner. The target tracking processor 26 then “follows” this group signals representing the target object in subsequent scans of the imaging device 12 to track the target as the video sequence progresses.

In another embodiment of the present invention, actuation of the target designator switch 39 causes the controller 36 to signal the target tracking processor to initiate tracking and the zoom processor 28 to begin zooming in. When the image of the tentative target is easy to view in the viewfinder 24 the user designates the target object a second time by actuating the target designator switch 39. The target object is tentatively identified for the target tracking processor 26 by the first actuation of the target designator switch 39 but the information about the size and location of the target is refined and verified in the magnified image where the target object is more visible.

The zoom processor 28 may then zoom out electronically or by actuating the zoom motor 34 to return the zoom to the original setting or some intermediate setting established by the user. The present inventors realized that zooming in on the target object would make it easier to locate the target object if it is at a distance from the camera or in low contrast or crowded surroundings. Further, automatically zooming the image provides a convenient method of establishing the target. This may likewise be performed with a touch sensitive display.

The algorithm applied by the target tracking processor 26 may include a measurement of the level of confidence that the target is being correctly tracked. If the level of confidence should decrease, the tracking processor 26 may cause the zoom processor 28 to begin zooming in. The changing magnification of the image in the viewfinder 24 notifies the user that the confidence level of the algorithm is low. Increasing the magnification of the image may cause the algorithm's confidence level to increase. On the other hand, if the algorithm cannot automatically reacquire the target object, increasing the magnification of the image will facilitate relocation of the target object by the user who may re-designate the target for the tracking system by actuating the target designator switch 39.

While tracking a target periodically the target may be obscured or otherwise not visible on the viewfinder 24 for a period of time. This may occur, for example, when another object comes in between the target and the camera for a period of time. When the target is not detected by the target tracking processor, the system may automatically switch into an alternative global tracking motion mode to predict where the object should be. In this manner, when the target is no longer obscured or otherwise not visible on the viewfinder 24 the target tracking processor will have an increased change of identifying the target to continue tracking. In this manner, the system is less likely to loose track of the target.

When the confidence of the system is sufficiently low (or losing the target totally) the present inventors came to the realization that most likely the target is no longer visible within the viewfinder 24. Accordingly, in such an event the system may automatically zoom out (or in) to present the viewer with an image having a greater (or lesser) field of view. In most instances, the target will be visible to the user within the new field of view image. The user then may select the target within this field of view in the manner described above, as desired. Alternatively, after the zooming in response to the confidence level the system may exit the tracking functionality.

Yet in another aspect of the present invention, the present inventors came to the realization that control over the amount of magnification provided by the system for the selection of the target should operate in an intuitive and efficient manner. The intuitive system developed by the present inventors includes the user selecting a target object for tracking, in any manner, such as those previously described. Preferably, after selecting the target object the tracking system tracks the target object. In the event that the user triggers another target object selection within a predetermined time period, then the system will cease object tracking, if object tracking was already initiated, and change the magnification of the image on the display. The same or a different object may be selected for the another target object selection. For example, the magnification for the target objection selection may be performed by, for example, clicking a mouse twice (or multiple times) or touching a display twice (or multiple times). After changing the magnification of the image, the system then permits the user to select a target object for tracking. Again, if the user triggers another target object selection within a predetermined time period, then the system will cease object tracking, if object tracking was already initiated, and change the magnification of the image on the display (such as increase magnification). This process is repeated until the user does not trigger another target object selection within a predetermined time period. This permits magnification of the image until the target can be easily selected for tracking. The target selected for tracking is preferably the last selected object. After tracking is initiated, and preferably the predetermined time period has elapsed, the system may return to a previous magnification, if desired.

While the tracking system has been described in relation to a video camera, the teachings are equally applicable to selection and tracking when viewing video, from any source, such as for example, a video cassette recorder, digital tape, analog tape, compact disc, and digital video disc.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A method of tracking a target for an object tracking system comprising the steps of:
(a) initiating said object tracking system;
(b) magnifying said image while said object tracking system is activated;
(c) selecting an object of interest in an image while said object tracking system is activated; and
(d) designating said object as said target of said tracking system while said object tracking system is activated.

2. The method of claim 1 wherein said image is magnified by adjustment of an optical lens.

3. The method of claim 1 wherein said image is magnified by adjusting an electrical signal representing, at least, a part of said image.

4. The method of claim 1 wherein said magnification is an automatic result of said initiating said object tracking system.

5. The method of claim 1, further comprising the step of automatically changing the scale of said image following designation of said object as said target.

6. The method of claim 1 wherein said object of interest is selected by the steps of:
(a) moving a cursor to superimpose said cursor on said object of interest in said image; and
(b) signaling said tracking system that said cursor is superimposed on said object of interest.

7. The method of claim 1 wherein said designating is using a touch sensitive display.

8. The method of claim 1 wherein said selecting said object of interest and said designating said object uses a different control mechanism than said magnifying said image.

9. The method of claim 1 wherein said selecting and said designating are performed simultaneously by touching a touch sensitive display.

10. The method of claim 9 wherein in response to initiating said object tracking system, said touch sensitive display is set to simultaneously said select and said designate upon the next touch of said touch sensitive display.

11. The method of claim 6 wherein said image is magnified by adjustment of an optical lens.

12. The method of claim 6 wherein said image is magnified by adjusting an electrical signal representing, at least, a part of said image.

13. The method of claim 6 wherein said magnification is an automatic result of said initiating said object tracking system.

14. The method of claim 6 further comprising the step of automatically changing the scale of said image following designation of said object as said target.

15. The method of claim 1 wherein said object of interest is selected by the steps of:
(a) moving said image to superimpose an image of a cursor on said object of interest; and
(b) signaling said tracking system that said cursor is superimposed on said object of interest.

16. The method of claim 15 wherein in response to initiating said object tracking system, said touch sensitive display is set to simultaneously said select and said designate upon the next touch of said touch sensitive display.

17. The method of claim 15 wherein said image is magnified by adjustment of an optical lens.

18. The method of claim 15 wherein said image is magnified by adjusting an electrical signal representing, at least, a part of said image.

19. The method of claim 15 wherein said magnification is an automatic result of said initiating said object tracking system.

20. The method of claim 15 further comprising the stop of automatically changing the scale of said image following designation of said object as said target.

21. A method of selecting a target for an object tracking system comprising the steps of:
(a) magnifying an image;
(b) designating an object in said image as a target for tracking by said tracking system; and
(c) in response to said designating of said object as said target, automatically changing the scale of said image.

22. The method of claim 21 wherein said image is magnified by adjustment of an optical lens.

23. The method of claim 21 wherein said image is magnified by adjusting electrical signals representing, at least, a part of said image.

24. The method of claim 21 wherein said magnification is an automatic result of initiating said object tracking system.

25. The method of claim 21 wherein said first and second designating of said object as said target comprises the steps of:
(a) moving a cursor to superimpose said cursor on said object in said image; and
(b) signaling said tracking system that said cursor is superimposed on said object.

26. The method of claim 21 wherein said first and second designating of said object as said target comprises the steps of:
(a) moving said image to superimpose a cursor on said object; and
(b) signaling said tracking system that said cursor is superimposed on said object.

27. The method of advising an operator of the performance of an object tracking system comprising the steps of:
(a) monitoring a level of confidence that said tracking system is tracking a target; and
(b) altering magnification of an image visible to said operator in response to a change in said level of confidence.

28. The method of claim 27 wherein said magnification is changed as said level of confidence decreases.

29. The method of claim 27 wherein said magnification is decreased if said object tracking system loses track of said target.

30. A method of selecting a target for an object tracking system comprising the steps of:
(a) a first designating of an object in said image as a target for tracking by said tracking system;
(b) magnifying said image if a second designating of at least one of said object and another object in said image is performed within a predetermined time period;
(c) repeating steps (a) and (b) until said second designating is not said performed, and in response tracking said object.

31. The method of claim 30 wherein said first designating of said object comprises the steps of:
(a) moving a cursor to superimpose said cursor on said object in said image; and
(b) signaling said tracking system that said cursor is superimposed on said object.

32. The method of claim 30 wherein further comprising the step of changing the magnification of said image in response to said tracking of said object.
